(19) United States
(12) Patent Application Publication
(10) Pub. No.: US 2026/0295627 A1
(43) Pub. Date: Oct. 1, 2026

(54) METHOD AND AN APPARATUS FOR COATING A MATERIAL WEB BY MEANS OF A SLOT NOZZLE

(71) Applicant: Jagenberg Converting Solutions GmbH, Bocholt (DE)

(72) Inventor: Daniel Eggerath, Hamburg (DE)

(21) Appl. No.: 19/569,059

(22) Filed: Mar. 17, 2026

(30) Foreign Application Priority Data
Mar. 31, 2025 (EP) 25 167 262.2

(51) Int. Cl. B05C 5/02

(52) U.S. Cl. CPC B05C 5/0262

(57) ABSTRACT

The invention relates to a method for coating a material web by means of a slot nozzle, wherein, during the transport of the material web in a transport direction, coating material exits via a slot of the slot nozzle and is thereby applied to the material web, wherein the slot has a coating width which extends perpendicularly to the transport direction along the material web, wherein the volume flow of the coating material passing through the slot can be variably adjusted along the coating width by means of an adjustment means. The method according to the invention is characterized in that, during the coating of the material web, pressure measurements are carried out, where in each pressure measurement, by means of a pressure sensor system, the pressure of the coating material in the slot of the slot nozzle is measured at a plurality of measurement positions along the coating width, thus obtaining pressure values for the plurality of measurement positions.

### FIELD OF THE INVENTION

The present invention relates to a method and an apparatus for coating a material web by means of a slot nozzle.

It is known from the prior art to apply coating material to a material web via a slot nozzle during an industrial production process, for example in battery production. The material web is moved in a transport direction during coating. After coating, the material web is usually transported through a drying apparatus in which the applied coating is dried.

In order to ensure that the coating material is applied with a uniform layer thickness in the direction transversely to the material web, use is made of thickness measurement systems which normally use electromagnetic radiation, such as X-ray radiation, or ultrasound to measure the layer thickness. Such systems are expensive and often do not have sufficient accuracy.

### SUMMARY

It is an object of the invention to carry out measurements in a simple manner during the coating of a material web by means of a slot nozzle, which measurements allow conclusions to be drawn about the uniformity of the layer thickness of the coating material applied to the material web.

This object is respectively solved by the method according to patent claim 1 and the apparatus according to patent claim 14. Preferred embodiments of the invention are defined in the dependent claims.

In the method according to the invention, a material web is coated by means of a slot nozzle. During the transport of the material web in a transport direction, coating material exits via a slot of the slot nozzle, as a result of which the coating material is applied to the material web. The slot has a coating width which extends perpendicularly to the transport direction along the material web. The volume flow of the coating material passing through the slot can be variably adjusted along the coating width by means of an adjustment means. Depending on the configuration, the adjustment means can be configured for manually changing the volume flow by an operator and/or for automatically changing the volume flow by means of an actuator system.

The method according to the invention is characterized in that, during the coating of the material web, pressure measurements are carried out, where in each pressure measurement, by means of a pressure sensor system, the pressure of the coating material in the slot of the slot nozzle is measured at a plurality of measurement positions along the coating width, thus obtaining pressure values for the plurality of measurement positions.

The obtained pressure values are at least temporarily stored digitally for further processing. Depending on the configuration of the method according to the invention, the obtained pressure values can be further processed differently. For example, they can be output and preferably visualized for an operator on a user interface. It is likewise possible for the pressure values to be used to automatically change the volume flow of the coating material in the slot of the slot nozzle if the adjustment means can automatically change the volume flow.

The invention is based on the finding that, by means of a pressure measurement in the slot of the slot nozzle, information is obtained which correlates with the layer thickness of the coating material applied to the material web. In particular, higher pressures correspond to higher flow velocities of the coating material on exiting from the slot of the slot nozzle, which in turn results in greater layer thicknesses. This information can be output to an operator via a user interface and/or it can be used to suitably change the volume flow of the coating material in order to achieve uniform layer thicknesses. It was possible to prove by means of simulations that there is a relationship between pressures measured in the slot and the flow velocities of the coating material on exiting from the slot. This is also explained once again in the detailed description.

In a preferred embodiment of the method according to the invention, for a respective pressure measurement, the pressure values as a function of the measurement positions and/or a pressure profile along the coating width, which is derived from the pressure values, are output via a user interface. The user interface is preferably a visual user interface, for example in the form of a display. I.e., the pressure values or the pressure profile are displayed in a suitable manner on the visual user interface. The pressure profile along the coating width can be determined, for example, by fitting a curve to the pressure values. This fit is carried out using a suitable computer means.

In a further preferred variant, the pressure sensor system comprises a plurality of pressure sensors which are arranged side by side along the coating width at the plurality of measurement positions. In this case, pressure sensors which are known per se can be used, examples of such pressure sensors being mentioned in the detailed description.

In a further embodiment, using a suitable computer means, an associated normalized velocity value for a respective pressure measurement is calculated from the pressure value at a respective measurement position by means of a predetermined relation. The normalized velocity value is, for a respective exit position from a plurality of exit positions, the deviation of the flow velocity of the coating material from the minimum flow velocity of the coating material at the plurality of exit positions, divided by the average flow velocity over the plurality of exit positions and multiplied by a numerical value greater than zero. In this case, each exit position is associated with a measurement position from the plurality of measurement positions, a respective exit position being the position of the exit of the coating material from the slot after passing through the associated measurement positions. This embodiment of the invention is based on the finding that there is a predetermined relation between pressure values and normalized flow velocities, with the result that normalized velocity values which in turn correlate with the layer thickness can be determined in a simple manner by means of this predetermined relation. The predetermined relation describes a linear relation. The above numerical value can be, for example, 1 or 0.5 or else any other desired value.

In a preferred variant of the above embodiment, for a respective pressure measurement, the normalized velocity values and/or a velocity profile derived from the normalized velocity values are output via a user interface. The velocity profile can in turn be calculated by a curve fit to the normalized velocity values. The user interface preferably corresponds to the user interface described above.

In a particularly preferred embodiment, using a suitable computer means, a pressure distribution parameter is calculated from a respective pressure measurement, where the pressure distribution parameter is a measure of the dispersion of the pressure values at the plurality of measurement positions around the average pressure value over the plurality of measurement positions (i.e. the pressure value averaged over the measurement positions). Subsequently, using the computer means, a velocity distribution parameter is determined from the pressure distribution parameter via a predetermined relation, wherein the velocity distribution parameter is a measure of the dispersion of the flow velocities of the coating material at a plurality of exit positions, wherein a measurement position from the plurality of measurement positions is associated with each exit position and a respective exit position is the position of the exit of the coating material from the slot after passing the associated measurement position. The predetermined relation corresponds to the predetermined relation described above, which can be used to calculate the normalized velocity values. Use is made in this embodiment of the finding that a relationship between a pressure distribution parameter and a velocity distribution parameter can also be described using the predetermined relation.

In a preferred variant of the above embodiment, the pressure distribution parameter is the difference between the maximum pressure value and the minimum pressure value at the plurality of measurement positions, divided by the average pressure value over the plurality of measurement positions (i.e. the pressure value averaged over the plurality of measurement positions) and multiplied by a numerical value greater than zero. Furthermore, the velocity distribution parameter is preferably the difference between the maximum flow velocity and the minimum flow velocity at the plurality of exit positions, divided by the average flow velocity over the plurality of exit positions (i.e. the flow velocity averaged over the plurality of exit positions) and multiplied by a numerical value greater than zero. The above numerical value can be, for example, 1 or 0.5 or else any other desired value. When the value 0.5 is used, a percentage deviation from the corresponding average value is expressed by the pressure distribution parameter or the velocity distribution parameter.

In a preferred variant, the pressure distribution parameter and/or the velocity distribution parameter can in turn be output via a user interface, wherein the user interface can be the same user interface as described above.

Depending on the configuration, the predetermined relation described above can be a relation which was determined in advance for the slot nozzle experimentally or via a simulation.

In a particularly preferred embodiment of the method according to the invention, the adjustment means is controlled automatically by means of a control device in such a manner that variations of the pressure values over the plurality of measurement positions are reduced. In other words, the measured pressure values serve to adjust the volume flow in the slot of the slot nozzle toward a uniform pressure distribution and therefore a layer thickness which is as constant as possible.

In a preferred variant of the above embodiment, the control device controls the adjustment means on the basis of an optimization with the optimization goal of a velocity distribution parameter which is as low as possible. Corresponding optimization methods or optimization algorithms are well-known to a skilled person.

In a further preferred embodiment, the adjustment means comprises a plurality of blocks which are arranged side by side along the coating width and can move into the slot and out of the slot in order for the purpose of varying the volume flow of the coating material. With such an adjustment means, the volume flow can be adapted in a simple manner by adjusting the position of the blocks. The adjustment means can be configured in such a way that the adjustment of the blocks is carried out manually by an operator. It is likewise possible for the adjustment means to comprise an actuator system in order to carry out the adjustment of the blocks automatically.

The method according to the invention can be used for coating any desired material webs with different coating materials. In a preferred variant, the material web is a substrate film which is coated with an electrode paste or a slurry as coating material in order to produce an electrode material web for the battery.

In addition to the method described above, the invention relates to an apparatus for coating a material web by means of a slot nozzle, wherein the apparatus is configured for an operation in which, during the transport of the material web in a transport direction, coating material exits via a slot of the slot nozzle and is thereby applied to the material web, wherein the slot has a coating width which extends perpendicularly to the transport direction along the material web, wherein the volume flow of the coating material passing through the slot can be variably adjusted along the coating width by means of an adjustment means. The apparatus according to the invention is configured to carry out, during the coating of the material web, pressure measurements, where in each pressure measurement, by means of a pressure sensor system, the pressure of the coating material in the slot of the slot nozzle is measured at a plurality of measurement positions along the coating width, thus obtaining pressure values for the plurality of measurement positions . . .

The apparatus according to the invention is therefore configured to carry out the method according to the invention. In a preferred variant, the apparatus according to the invention is furthermore configured to carry out one or more preferred embodiments of the method according to the invention. In other words, the apparatus contains corresponding means for carrying out one or more preferred variants of the method according to the invention, such a computer means for carrying out the calculations described above.

### BRIEF DESCRIPTION OF THE DRAWINGS

Embodiments of the invention are described in detail below with reference to the accompanying drawings, wherein

FIG. 1 is a schematic sectional view through an embodiment of an apparatus according to the invention for coating a material web;

FIG. 2 is a sectional view perpendicularly to the sheet plane of FIG. 1 along the T-bars;

FIG. 3 is a diagram which, for different T-bar positions, reproduces the relation between the position along the coating width and the pressure in the slot of the slot nozzle during the coating of the material web;

FIG. 4 is a diagram which, for different T-bar positions, reproduces the relation between the position along the coating width and the flow velocity of the coating material on exiting from the slot of the slot nozzle during the coating of the material web;

FIG. 5 is a diagram which reproduces the dependence of a pressure distribution parameter on a corresponding velocity distribution parameter;

FIG. 6 is a diagram which, for a T-bar position, reproduces the relation between the position along the coating width and a normalized velocity value; and

FIG. 7 is a schematic illustration of a control device which is used in a variant of the apparatus according to the invention.

### DETAILED DESCRIPTION

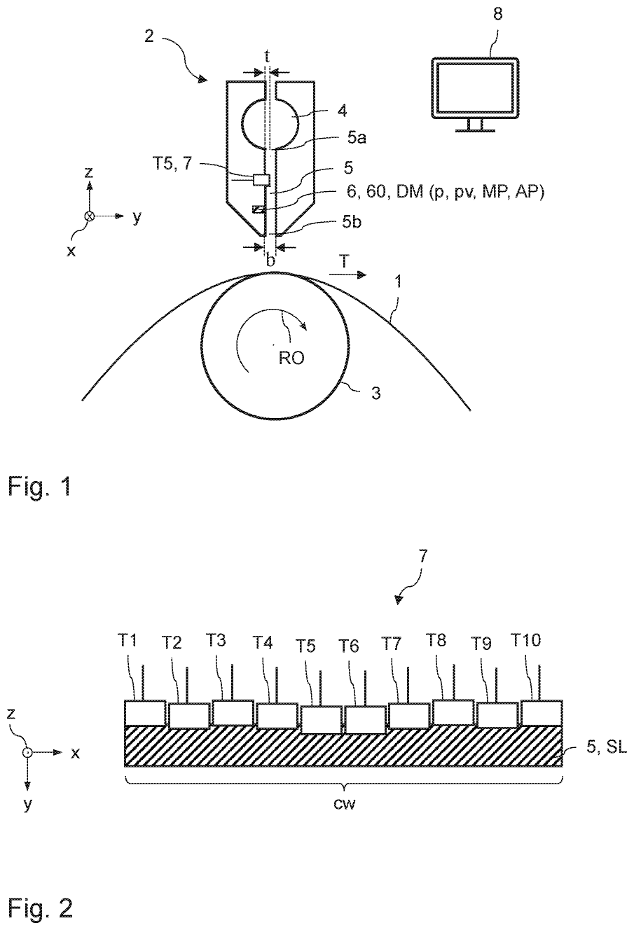

FIG. 1 shows, in a sectional view, a slot nozzle which is used in an embodiment of the invention for coating a material web. The slot nozzle is denoted by reference sign 2 and the material web is denoted by reference sign 1. In FIG. 1 and FIG. 2, a Cartesian coordinate system with x-axis, y-axis and z-axis is shown. The x-axis or x-direction corresponds to the extent of the material web 1 in the width direction. The y-axis or y-direction correlates with the extent of the material web 1 in the longitudinal direction. The z-axis or z-direction represents the vertical direction or height direction.

The slot nozzle 2 is arranged above the material web 1, which is advanced during the coating by means of a transport roller 3. The transport roller rotates in the illustrated rotation direction RO, with the result that the material web 1 is moved from left to right in the illustrated transport direction T. In the exemplary embodiment shown, the material web 1 is a substrate film to which a coating material SL in the form of an electrode paste (slurry) is to be applied in order to produce an electrode material web for a battery. Nevertheless, the invention can also be used for coating other material webs with different coating materials.

The coating material SL is conveyed via a pump (not shown) into a distribution chamber 4 of the slot nozzle 2 and passes via the distribution chamber 4 to a slot 5 within the slot nozzle 2. The coating material SL is not shown in FIG. 1 for reasons of clarity. However, the coating material is indicated by a hatched area in the illustration in FIG. 2.

The slot 5 has a slot width b in the y-direction. The length of the slot is given by its extent in the z-direction from its inlet opening 5a adjacent to the distribution chamber 4 to its outlet opening 5b adjacent to the material web 1. The extent of the slot 5 in the x-direction is shown in the sectional view of FIG. 2. In this direction, the slot 5 has a coating width cw which corresponds to the width with which coating material SL is applied to the material web 1.

The coating material SL exits downwards from the slot 5 and is applied as a thin film to the material web 1 during the transport thereof in the transport direction T. The layer thickness of the applied coating material should be as constant as possible. In order to suitably adjust the layer thickness along the coating width cw, ten so-called T-bars T1 to T10 are provided side by side in the x-direction and are part of an adjustment means 7. Only the T-bar T5 can be seen from FIG. 1 since the sectional view in FIG. 1 extends through it.

The arrangement of the T-bars T1 to T10 in the x-direction is shown in the view of FIG. 2 which illustrates a sectional view in the height of the T-bars along the sectional plane which is spanned by the x-axis and γ-axis. It can be seen that the position of the individual T-bars in the y-direction can be varied. By varying this position, the penetration depth of the respective T-bars into the slot 5 can be changed and in this way the flow velocity of the coating material in the slot can be influenced. The deeper a corresponding T-bar penetrates into the slot 5, the lower are the volume flow and the flow velocity of the coating material in the region of the corresponding T-bar. This in turn results in a lower layer thickness of the applied coating material since there is a linear relation between the flow velocity and the layer thickness. The penetration depth t of the T-bars is denoted by t in FIG. 1. This results in a reduced slot width b′=b−t in the region of the corresponding T-bar.

In one variant of the invention, the positions of the T-bars in the y-direction can be adjusted manually by an operator by means of an adjusting screw. In another variant of the invention, the adjustment means 7 can be configured as an automatic device using electrically controllable actuators (not shown) for the individual T-bars in order to vary the position of the respective T-bars in the y-direction.

An essential aspect of the present invention is that a pressure sensor system 60 is provided in the slot 5 in order to measure the pressure of the coating material along the coating width cw. The pressure sensor system 60 comprises ten pressure sensors 6, one of which can be seen from FIG. 1. Sensors which are known per se can be used as pressure sensors, for example the 33X series pressure sensor from Keller or the Cerabar PMC51 pressure sensor from Endress+Hauser. Each pressure sensor 6 is associated with one of the T-bars T1 to T10 and is positioned downstream of the corresponding T-bar in the slot 5. During the coating of the material web 1, the pressure sensor system 60 carries out pressure measurements DM at regular intervals. To do so, the pressure p at the corresponding location in the slot 5 is measured using the individual pressure sensors 6. As a result, pressure values pv are obtained at measurement positions MP in the slot (i.e. the positions of the pressure sensors 6). Each measurement position MP correlates with an exit position AP at which the coating material SL exits from the outlet opening 5b of the slot 5 after passing the corresponding measurement position MP.

FIG. 1 schematically shows a user interface 8 which is a visual user interface in the form of a display. In one embodiment of the invention, the pressures detected by means of the pressure sensors 6 are visualized to the operator on the display, as will be explained in more detail further below.

The invention is based on the finding that the pressures measured at the measurement positions MP by means of the pressure sensor system 60 are correlated with the flow velocities of the coating material at the corresponding exit positions AP and consequently with the layer thickness of the coating material applied to the material web. Consequently, the uniformity of the thickness of the applied coating can be checked very well by means of the pressure measurements. In other words, constant pressures along the coating width lead to the conclusion that the layer thickness is constant.

The above finding could be verified by CFD simulations (CFD-Computational Fluid Dynamics) based on the OpenFOAM® software known per se. In the simulations, a slot nozzle corresponding to the design of FIG. 1 was simulated. This simulated slot nozzle has a coating width cw of 250 mm. The length of the slot of the slot nozzle from the distribution chamber to the outlet opening of the slot is 40 mm. The slot width b is 2 mm. The slot nozzle comprises ten T-bars with a respective width of 25 mm in the direction transversely to the material web. The simulations were based on an electrode paste for an anode as coating material, which electrode paste exits from the distribution chamber 4 at a volume flow of 500 ml/min. The velocity of the material web in the transport direction T is 50 m/min.

Eight simulations were carried out with different T-bar positions PO1 to PO8. A respective T-bar position defines the penetration depth t or the reduced slot width b′=b-t for all ten T-bars. The T-bar positions used in the simulations are indicated in the following table:

| | b′ for | b′ for | b′ for | b′ for | b′ for | b′ for | b′ for | b′ for | b′ for | b′ for |
|---|---|---|---|---|---|---|---|---|---|---|
| | T1 (μm) | T2 (μm) | T3 (μm) | T4 (μm) | T5 (μm) | T6 (μm) | T7 (μm) | T8 (μm) | T9 (μm) | T10 (μm) |
| PO1 | 750 | 750 | 750 | 750 | 680 | 680 | 750 | 750 | 750 | 750 |
| PO2 | 740 | 740 | 740 | 740 | 720 | 720 | 740 | 740 | 740 | 740 |
| PO3 | 740 | 740 | 740 | 740 | 740 | 740 | 740 | 740 | 740 | 740 |
| PO4 | 750 | 750 | 750 | 740 | 740 | 740 | 740 | 750 | 750 | 750 |
| PO5 | 750 | 750 | 750 | 750 | 740 | 740 | 750 | 750 | 750 | 750 |
| PO6 | 750 | 750 | 750 | 750 | 750 | 750 | 750 | 750 | 750 | 750 |
| PO7 | 750 | 750 | 750 | 740 | 735 | 735 | 740 | 750 | 750 | 750 |
| PO8 | 750 | 750 | 745 | 740 | 735 | 735 | 740 | 745 | 750 | 750 |

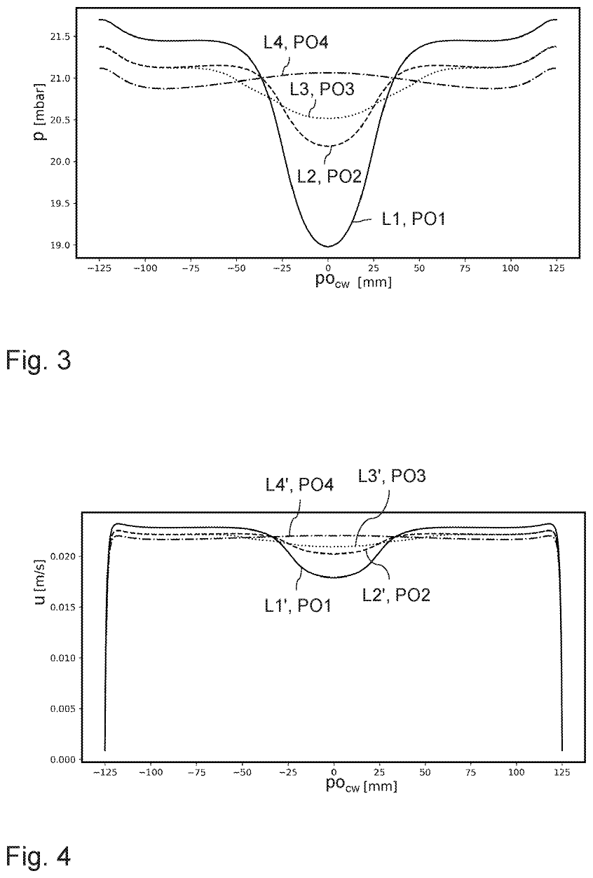

The profile of the pressure p along the coating width cw was determined by means of the CFD simulations. In the diagram in FIG. 3, this profile is indicated by way of example for the four T-bar positions PO1, PO2, PO3 and PO4 by corresponding lines L1, L2, L3 and L4. The abscissa in FIG. 3 specifies the positions po_{cw} along the coating width. The ordinate in FIG. 3 specifies the pressure p at the corresponding positions. Furthermore, the profile of the flow velocity u of the coating material along the coating width cw on exiting from the slot of the nozzle was determined by means of the CFD simulations. In the diagram in FIG. 4, this profile is indicated by way of example for the four T-bar positions PO1, PO2, PO3 and PO4 by corresponding lines L1′, L2′, L3′ and L4′. The abscissa in FIG. 4 specifies the positions po_{cw} along the coating width. The ordinate in FIG. 4 specifies the flow velocity u of the coating material at the corresponding positions.

As can be seen from FIGS. 3 and 4, the pressures p and the flow velocities u of the same T-bar positions have the same qualitative profile. Therefore, in one variant of the invention, in which the positions of the individual T-bars can be adjusted manually, the pressure values pv of the respective pressure measurements DM are visualized on the display of the user interface 8, with the result that the operator receives feedback as to the extent to which the flow velocity and therefore the layer thickness of the applied coating material are constant along the coating width cw. The pressure values pv can be output on the display of the user interface 8, for example as a list. However, they are preferably illustrated in a diagram analogously to FIG. 3, wherein a pressure profile is preferably reproduced by fitting a curve to the pressure values pv.

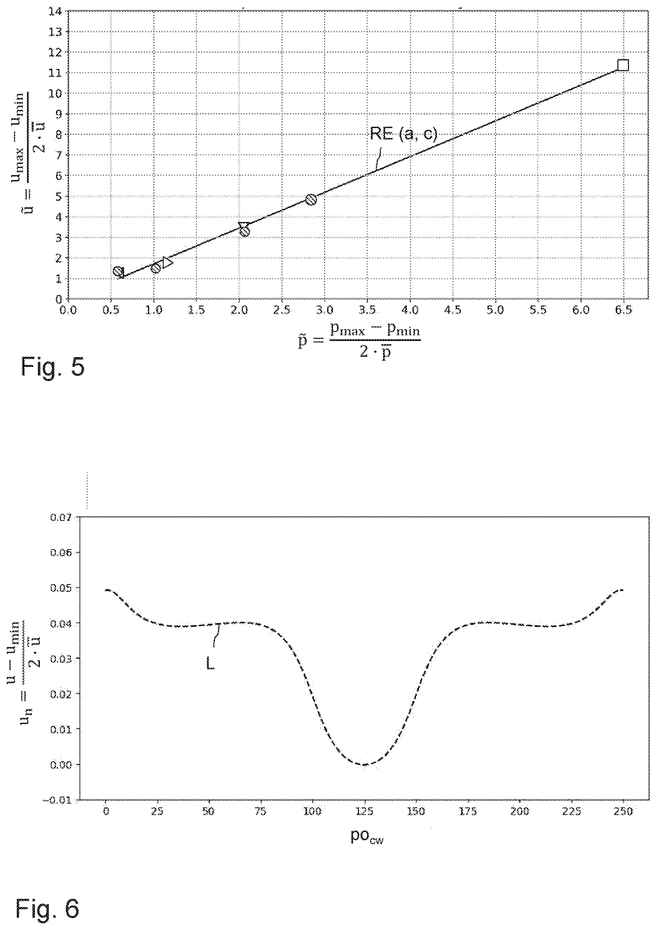

FIG. 5 shows a diagram which shows the dependence of pressure distribution parameters p which were determined from the pressure profiles in FIG. 3 on velocity distribution parameters which were determined from the velocity profiles in FIG. 4. In this case, the circles, triangles and the rectangle which are shown in the diagram in FIG. 5 correspond to a respective data point which is correlated with one of the T-bar positions PO1 to PO8 according to the above table and therefore with the associated profiles from FIG. 3 and FIG. 4.

The corresponding pressure distribution parameter is given by the following equation:

$$\tilde{p} = \frac{{p}_{max} - {p}_{min}}{2 \cdot \overline{p}} \qquad ( 1 )$$

wherein pₘₐₓ is the maximum pressure from the pressure profile in FIG. 3 for the corresponding T-bar position;
wherein pₘᵢₙ is the minimum pressure from the pressure profile in FIG. 3 for the corresponding T-bar position;
wherein p̅ is the mean pressure from the pressure profile in FIG. 3 for the corresponding T-bar position;
The pressure distribution parameter p is a measure of the dispersion of the pressures determined by the pressure sensors 6 at the measurement positions MP.

The corresponding velocity distribution parameter is given by the following equation:

$$\tilde{u} = \frac{{u}_{max} - {u}_{min}}{2 \cdot \overline{u}} \qquad ( 2 )$$

wherein uₘₐₓ is the maximum flow velocity from the velocity profile in FIG. 4 for the corresponding T-bar position;
wherein uₘᵢₙ is the minimum flow velocity from the velocity profile in FIG. 4 for the corresponding T-bar position;
wherein u is the mean flow velocity for the velocity profile in FIG. 4 for the corresponding T-bar position;
The velocity distribution parameter u is a measure of the dispersion of the flow velocities of the coating material at the exit positions AP, which flow velocities correlate with the respective measurement positions MP.

As can be seen from FIG. 5, there is a linear relation RE between the pressure distribution parameter p and the velocity distribution parameter ũ. In other words, a straight line having a slope a and an offset c can be fitted to the data points shown in FIG. 5. In one variant of the invention, the pressure values pv obtained from the pressure measurements DM are processed in a computer (not shown) which determines the corresponding pressure distribution parameter p from the pressure values. Using the relation RE which was obtained in advance from the simulations according to FIG. 3 and FIG. 4, the computer determines the associated velocity distribution parameter ũ. The velocity distribution parameter can then be output via the display of the user interface 8, wherein, in addition, the pressure distribution parameter p can also be displayed on the display. The greater the velocity distribution parameter, the greater the dispersion of the flow velocities of the coating material on exiting from the nozzle, i.e. the more uneven is the layer thickness of the coating material applied to the material web. The displayed velocity distribution parameter therefore gives the operator information about whether the layer thickness is uniform.

Using the relation RE, a normalized flow velocity uₙ can also be determined as follows:

$${u}_{n} = \frac{u - {u}_{min}}{2 \cdot \overline{u}} = a \cdot \frac{p - {p}_{min}}{2 \cdot \overline{p}} + c \qquad ( 3 )$$

The pressure value p in the above equation (3) correlates with the pressure at the corresponding measurement position, which in turn is linked with a position po_{cw} along the coating width.

FIG. 6 shows a diagram which reproduces the profile L of the above normalized velocity uₙ as a function of the position po_{cw} along the coating width for the simulated pressures according to the T-bar position PO2 (line L2 from FIG. 3).

In one variant of the invention, normalized velocities uₙ for pressures measured by the pressure sensors 6 are determined using the relation RE by means of a computer (not shown) and output via the display of the user interface 8. In this case, the normalized velocities are illustrated as data points in a diagram corresponding to FIG. 6. If appropriate, a profile of the normalized velocities can also be output by fitting a curve to the data points. Via this illustration, the operator again receives suitable feedback about the uniformity of the layer thickness of the applied coating material.

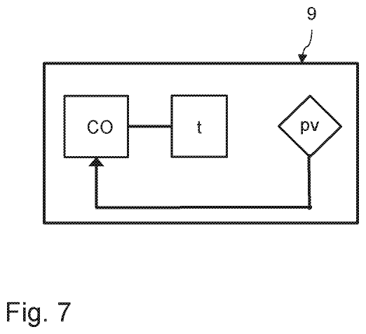

FIG. 7 schematically shows a control device 9 which is used in a variant of the invention in which the positions of the T-bars can be adjusted automatically. The control device 9 has a control program CO which is stored on a computer unit of the control device 9. The control program CO processes the pressure values pv measured by the pressure sensors 6. In case of a great deviation between the pressure values, an adjustment of the T-bars is carried out by means of an optimization which is known per se. The adjustment results in a more uniform pressure distribution along the coating width and therefore in a more uniform layer thickness. In other words, the control program CO outputs suitable penetration depths t as a function of the measured pressure values pv, which penetration depths are then adjusted for the corresponding T-bars. Based the optimization carried out by the control program CO, it is possible, for example, to use the velocity distribution parameter u which is determined from the predetermined relation RE. The optimization goal is in this case a value of the velocity distribution parameter which is as low as possible and which correlates with a uniform layer thickness of the coating material applied to the material web. Corresponding optimization algorithms for implementing the above optimization goal are well-known to a skilled person and are therefore not explained further.

The embodiments of the invention described above have several advantages. In particular, a measurement is carried out for the first time directly in the slot of a slot nozzle, which measurement allows conclusions about the uniformity of the thickness of the coating applied via the slot nozzle. In this respect, it has been recognized that a pressure measurement directly allows a conclusion about the layer thickness, for which reason corresponding pressure sensors are provided on the slot. The pressure values of the pressure sensors or flow velocities derived therefrom can be visualized to an operator via a user interface, which operator can subsequently adjust the T-bars of the slot nozzle in order to achieve a uniform layer thickness. If appropriate, the positions of the T-bars can also be adjusted automatically. In this case, the measured pressures can be used by a closed-loop control which adjusts the positions of the T-bars in such a way that more uniform layer thicknesses are achieved.

### LIST OF REFERENCE SIGNS

1 material web
2 slot nozzle
3 transport roller
4 distribution chamber
5 slot
5a inlet opening of the slot
5b outlet opening of the slot
6 pressure sensor
60 pressure sensor system
7 adjustment means
8 user interface
9 control device
T1, T2, . . . , T10 T-bars
SL coating material (electrode paste)
T transport direction of the material web
RO rotation direction of the transport roller
t distance with which a T-bar protrudes into the slot
DM pressure measurement
p pressure
pv pressure value
MP measurement position
AP exit position
b slot width
cw coating width
x, y, z coordinates of a Cartesian coordinate system
po_{cw} position along the coating width
u flow velocity
L1, L2, L3, L4 pressure profiles
PO1, PO2, PO3, PO4 T-bar positions
L1′, L2′, L3′, L4′ velocity profiles
\tilde{p} pressure distribution parameter
ũ velocity distribution parameter
RE predetermined relation
a slope of the straight line of the predetermined relation
c offset of the straight line of the predetermined relation
pₘₐₓ maximum pressure value
pₘᵢₙ minimum pressure value
p̅ average pressure value
uₘₐₓ maximum flow velocity
uₘᵢₙ minimum flow velocity
ū average flow velocity
uₙ normalized velocity value
L profile of the normalized velocity
CO control program

1. A method for coating a material web by means of a slot nozzle, wherein, during the transport of the material web in a transport direction, coating material exits via a slot of the slot nozzle and is thereby applied to the material web, wherein the slot has a coating width which extends perpendicularly to the transport direction along the material web, wherein the volume flow of the coating material passing through the slot can be variably adjusted along the coating width by means of an adjustment means, wherein
during the coating of the material web, pressure measurements are carried out, where in each pressure measurement, by means of a pressure sensor system, the pressure of the coating material in the slot of the slot nozzle is measured at a plurality of measurement positions along the coating width, thus obtaining pressure values for the plurality of measurement positions.

2. The method according to claim 1, wherein, for a respective pressure measurement, the pressure values as a function of the measurement positions and/or a pressure profile along the coating width, which is derived from the pressure values, are output via a user interface.

3. The method according to claim 1, wherein the pressure sensor system comprises a plurality of pressure sensors which are arranged side by side along the coating width at the plurality of measurement positions.

4. The method according to claim 1, wherein, for a respective pressure measurement, by means of a predetermined relation, an associated normalized velocity value (uₙ) is calculated from the pressure value at a respective measurement position, where the associated normalized velocity value is, for a respective exit position from a plurality of exit positions, the deviation of the flow velocity (u) of the coating material from the minimum flow velocity of the coating material at the plurality of exit positions, divided by the average flow velocity over the plurality of exit positions and multiplied by a numerical value greater than zero, wherein a measurement position from the plurality of measurement positions is associated with each exit position and a respective exit position is the position of the exit of the coating material from the slot after passing the associated measurement position.

5. The method according to claim 4, wherein, for a respective pressure measurement, the normalized velocity values as a function of the exit positions and/or a velocity profile along the coating width, which is derived from the normalized velocity values, are output via a user interface.

6. The method according to claim 1, wherein a pressure distribution parameter is calculated from a respective pressure measurement, where the pressure distribution parameter is a measure for the dispersion of the pressure values at the plurality of measurement positions around the average pressure value over the plurality of measurement positions, wherein a velocity distribution parameter is determined from the pressure distribution parameter via a predetermined relation, where the velocity distribution parameter is a measure for the dispersion of the flow velocities of the coating material at a plurality of exit positions, wherein a measurement position from the plurality of measurement positions is associated with each exit position and a respective exit position is the position of the exit of the coating material from the slot after passing the associated measurement position.

7. The method according to claim 6, wherein the pressure distribution parameter is the difference between the maximum pressure value and the minimum pressure value at the plurality of measurement positions, divided by the average pressure value over the plurality of measurement positions and multiplied by a numerical value greater than zero, and/or in that the velocity distribution parameter is the difference between the maximum flow velocity and the minimum flow velocity at the plurality of exit positions, divided by the average flow velocity (ū) over the plurality of measurement positions and multiplied by a numerical value greater than zero.

8. The method according to claim 7, wherein the pressure distribution parameter and/or the velocity distribution parameter are output via a user interface.

9. The method according to claim 4, wherein the predetermined relation is a relation which was determined in advance for the slot nozzle experimentally or via a simulation.

10. The method according to claim 1, wherein the adjustment means is controlled automatically by means of a control device in such a manner that variations of the pressure values over the plurality of measurement positions are reduced.

11. The method according to claim 10 wherein the control device controls the adjustment means on the basis of an optimization with the optimization goal of a velocity distribution parameter which is as low as possible.

12. The method according to claim 1, wherein the adjustment means comprises a plurality of blocks which are arranged side by side along the coating width and can move into the slot and out of the slot for the purpose of varying the volume flow of the coating material.

13. The method according to claim 1, wherein the material web is a substrate film which is coated with an electrode paste as coating material in order to produce an electrode material web for a battery.

14. An apparatus for coating a material web by means of a slot nozzle, wherein the apparatus is configured for an operation in which, during the transport of the material web in a transport direction, coating material exits via a slot of the slot nozzle and is thereby applied to the material web, wherein the slot has a coating width which extends perpendicularly to the transport direction along the material web, wherein the volume flow of the coating material passing through the slot can be variably adjusted along the coating width by means of an adjustment means, wherein
the apparatus is configured to carry out pressure measurements during the coating of the material web, where in each pressure measurement, by means of a pressure sensor system, the pressure of the coating material in the slot of the slot nozzle is measured at a plurality of measurement positions along the coating width, thus obtaining pressure values for the plurality of measurement positions.

15. The apparatus according to claim 14, wherein the apparatus is configured to carry out a method.
